(19) United States
(12) Patent Application Publication
(10) Pub. No.: US 2023/0126494 A1
(43) Pub. Date: Apr. 27, 2023

(54) LOWER VEHICLE-BODY STRUCTURE

(71) Applicant: HONDA MOTOR CO., LTD., Tokyo (JP)

(72) Inventor: Hidefumi NIHEI, Tokyo (JP)

(21) Appl. No.: 17/963,619

(22) Filed: Oct. 11, 2022

(30) Foreign Application Priority Data
Oct. 21, 2021 (JP) 2021-172097

(51) Int. Cl. B62D 25/02

(52) U.S. Cl. CPC B62D 25/025

(57) ABSTRACT

A lower vehicle-body structure includes: side sills extending along a vehicle front-rear direction and provided on both sides in a vehicle width direction of a vehicle body, respectively; a front undercover covering a lower surface of the vehicle body and having a first flange which extends to an outer bottom surface of each of the side sills; and a side sill garnish having a second flange covering the outer bottom surface from outside in the vehicle width direction. The first flange and the second flange are overlapped with each other in a vehicle up-down direction, and are fastened together to the outer bottom surface of the side sill.

### CROSS-REFERENCE TO RELATED APPLICATION

The present application claims the benefit of priority to Japanese Patent Application No. 2021-172097 filed on Oct. 21, 2021, the disclosures of all of which are hereby incorporated by reference in their entireties.

### TECHNICAL FIELD

### Field of the Disclosure

The present disclosure relates to a lower vehicle-body structure of an automobile.

### Related Art

For example, Japanese Patent No. 6608712 (referred to as Patent Document 1 hereinbelow), discloses side sills as a vehicle body frame member arranged at both sides in a vehicle width direction of a lower vehicle-body, along a vehicle front-rear direction, respectively.

Further, Patent Document 1 discloses side sill garnishes as exterior members arranged below the side sills. Fastening parts at inner ends in the vehicle width direction of the side sill garnishes are fastened to fastening parts at outer ends in the vehicle width direction of an undercover, with use of clips.

### SUMMARY OF THE DISCLOSURE

With the fastening structure at the lower vehicle-body disclosed in Patent Document 1, such as when a vehicle collides with a curb and one of the side sill garnish and the undercover arranged at the lower vehicle-body is damaged, there is a risk that the other of the two may be detached from said one of the two.

In view of the problem above, the present disclosure is intended to provide a lower vehicle-body structure so as to improve fastening rigidity and prevent the side sill garnish and the undercover from being detached from each other.

To achieve said objective, the present disclosure provides a lower vehicle-body structure including: side sills extending along a vehicle front-rear direction and provided on both sides in a vehicle width direction of a vehicle body, respectively; an undercover covering a lower surface of the vehicle body and having a first flange which extends to an outer bottom surface of each of the side sills; and a side sill garnish having a second flange covering the outer bottom surface of the side sill from outside in the vehicle width direction, wherein the first flange and the second flange are overlapped with each other in a vehicle up-down direction, and are fastened together to the outer bottom surface of the side sill.

The present disclosure provides a lower vehicle-body structure capable of improving fastening rigidity and preventing a side sill garnish and an undercover from being detached from each other.

### BRIEF DESCRIPTION OF THE DRAWINGS

FIG. 1 is a bottom view of a lower vehicle-body applied with a lower vehicle-body structure according to an embodiment of the present disclosure;

FIG. 2 is an enlarged cross-sectional view, taken along a line II-II in FIG. 1;

FIG. 3 is a bottom view of a scene in FIG. 1, with a side sill garnish removed;

FIG. 4 is a partially transparent bottom view of a scene in FIG. 3 in which a floor undercover is seen through;

FIG. 5 is a cross-sectional view of a fastening-and-fixing part configured to fasten and fix the side sill garnish to a sidewall center of an outer side sill;

FIG. 6 is an enlarged schematic structural view of a structure of the fastening-and-fixing part shown in FIG. 5;

FIG. 7 is a bottom view of the lower vehicle-body, with hinges of the side sill garnish opened;

FIG. 8 is an enlarged cross-sectional view of a scene, with the hinge of the side sill garnish closed to fasten together three members; and

FIG. 9 is an enlarged cross-sectional view of a scene, with the hinge of the side sill garnish opened.

### DESCRIPTION OF THE EMBODIMENTS

Next, a description is given in detail of an embodiment of the present disclosure, with reference to the drawings as appropriate. Note that, in each drawing, “front-rear” indicates a vehicle front-rear direction, “right-left” indicates a vehicle width direction (right-left direction), and “up-down” indicates a vehicle up-down direction (vertically up-down direction), respectively.

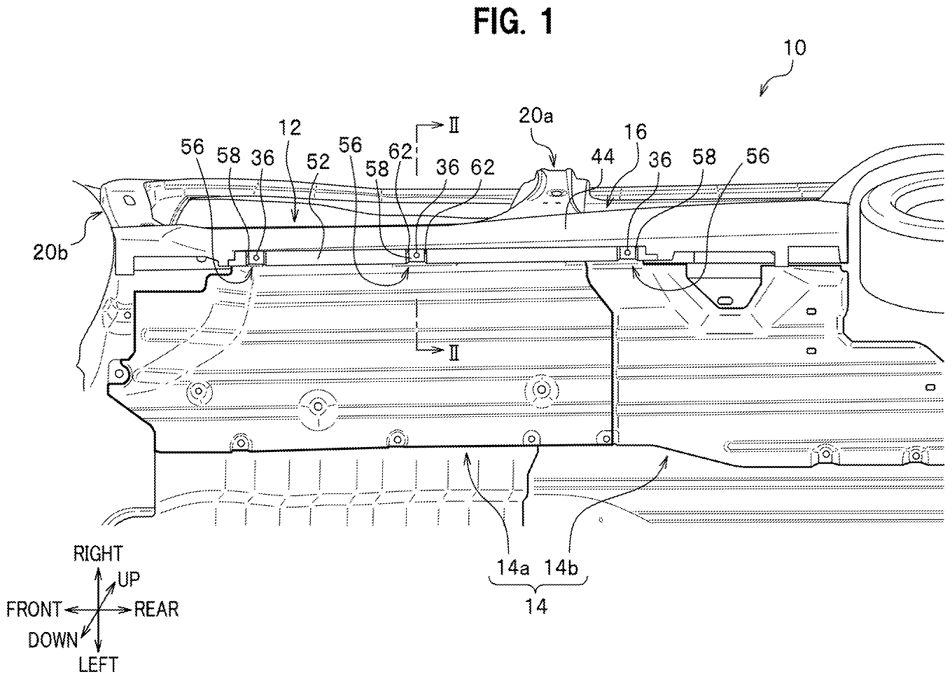

As shown in FIG. 1, a lower vehicle-body 10 applied with a lower vehicle-body structure according to the embodiment of the present disclosure includes a pair of right and left side sills 12, an undercover 14, and a pair of right and left side sill garnishes 16. Each side sill 12 serves as a frame member of a vehicle body. Note that, in FIGS. 1 to 3, only a right side of the lower vehicle-body is shown, and a left side thereof is not shown.

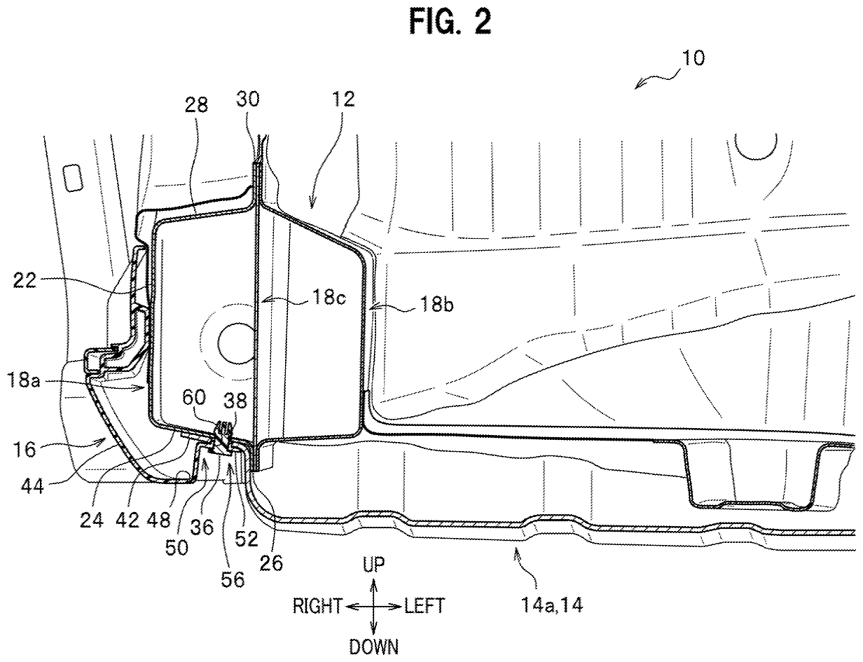

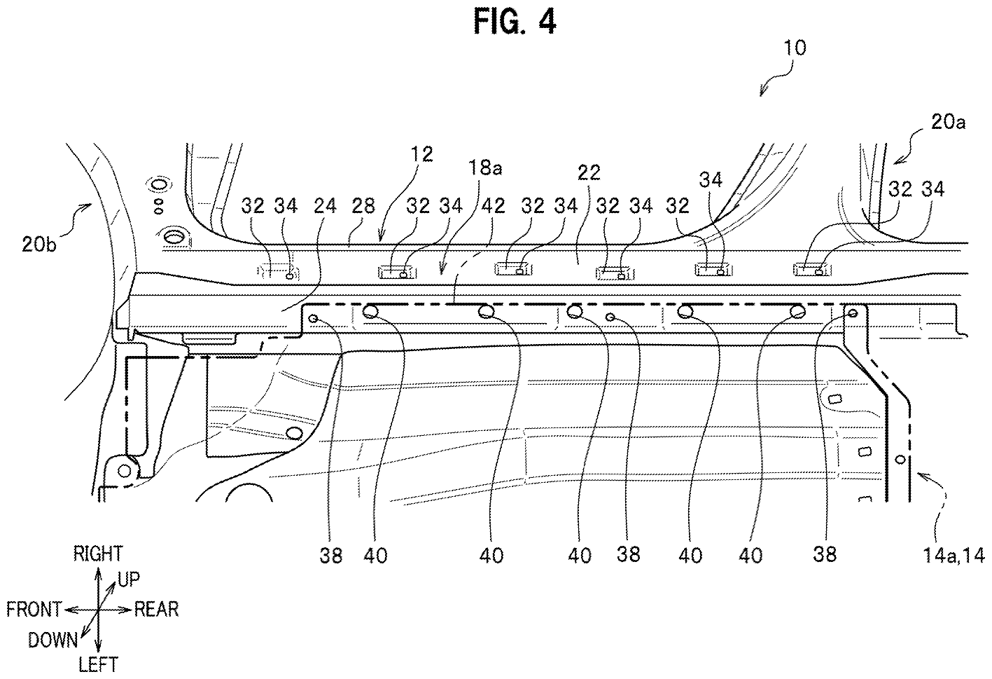

The side sills 12 are arranged on both sides in the vehicle width direction of the lower vehicle-body and extending in the vehicle front-rear direction, respectively. Further, as shown in FIG. 2, each side sill 12 includes an outer side sill 18a arranged on an outer side in the vehicle width direction thereof and having a hat shape in an axial cross section, an inner side sill 18b arranged on an inner side in the vehicle width direction thereof and having a hat shape in the axial cross section, and a side sill stiffener 18c interposed between the outer side sill 18a and the inner side sill 18b to serve as a reinforcing member. Note that each side sill 12 is coupled to lower ends of a center pillar 20a and a front pillar 20b, both vertically extending toward a roof (not shown) (see FIG. 4).

The outer side sill 18a, the inner side sill 18b, and the side sill stiffener 18c are joined together by upper end joining flanges and lower end joining flanges thereof, respectively.

As shown in FIG. 2, the outer side sill 18a has, in the axial cross-section thereof, a sidewall center 22 protruding outward in the vehicle width direction, an outer bottom surface 24 continuous to a lower end of the sidewall center 22 and bent toward the inner side sill 18b (inner side in the vehicle width direction), and a lower end joining flange 26 continuous to a lower end of the outer bottom surface 24. Further, the outer side sill 18a has, in the axial cross-section thereof, an outer top surface 28 continuous to an upper end of the sidewall center 22 and bent toward the inner side sill 18b (inner side in the vehicle width direction), and an upper end joining flange 30 continuous to an upper end of the outer top surface 28.

As shown in FIG. 4, the sidewall center 22 of the outer side sill 18a is formed with rectangular recesses 32, each having a substantially rectangular shape in a lateral view and recessed from the outer side inward in the vehicle width direction. A bottom wall of each rectangular recess 32 is formed with a fastening-and-fixing hole 34 for fastening and fixing the side sill garnish 16 to the side sill 12, at a portion other than the outer bottom surface 24. The fastening-and-fixing holes 34 each have a substantially rectangular shape in a lateral view and are formed along an axial direction of the side sill 12 at predetermined intervals. Note that, the present embodiment has six fastening-and-fixing holes 34 but is not limited thereto.

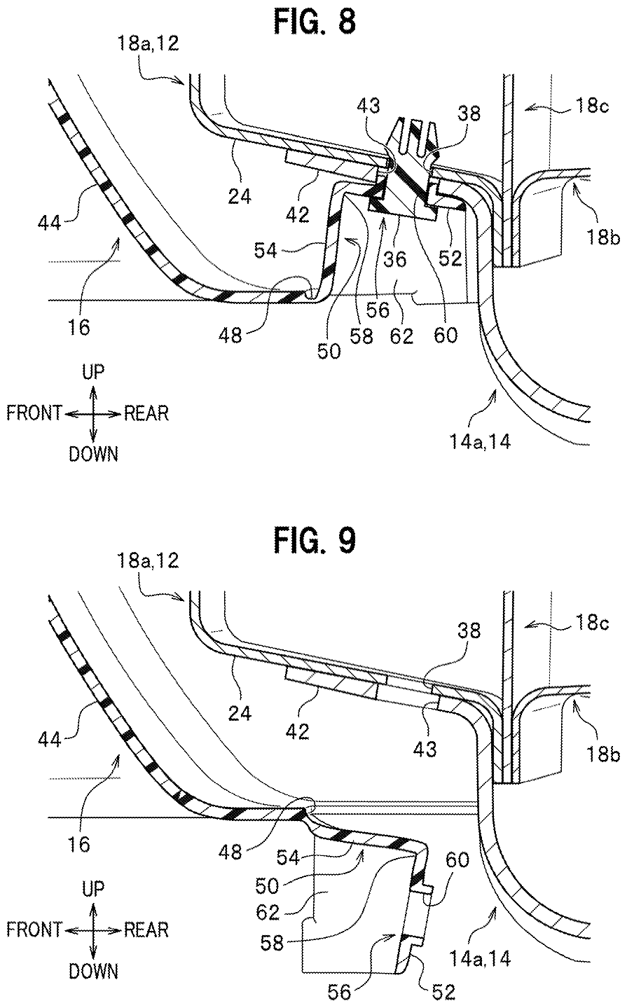

The outer bottom surface 24 of the outer side sill 18a is formed with clip insertion holes 38. Clips 36 to serve as fastening elements are inserted into the clip insertion holes 38 and other clip insertion holes 43 and 60 to be described below, to fasten together three members, which are the undercover 14, the side sill garnish 16, and the side sill 12, along the vehicle up-down direction (see FIG. 8). The clip insertion holes 38 are formed along the axial direction of the side sill 12 (vehicle front-rear direction) (see FIG. 4). Note that the present embodiment has the three clip insertion holes 38 (at a relatively front of the vehicle body, at the center of the vehicle body, and at a relatively rear of the vehicle body) but is not limited thereto.

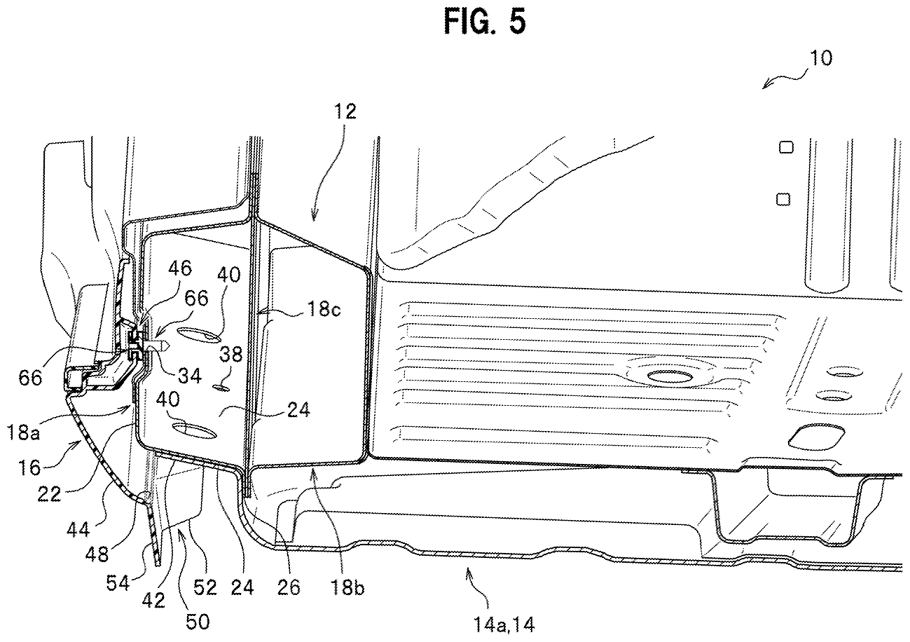

Further, the outer bottom surface 24 of the outer side sill 18a is formed with a plurality of electrodeposition coating holes 40 (see FIGS. 4 and 5). The electrodeposition coating holes 40 each have a circular shape having a larger diameter than that of the clip insertion hole 38 as viewed from the bottom and are formed along the axial direction of the side sill 12 at predetermined intervals. With the clips 36 inserted into the respective clip insertion holes 38 to fasten together the three members mentioned above (undercover 14, side sill garnish 16, and side sill 12), the respective electrodeposition coating holes 40 are closed by a first flange 42 of the undercover 14 (see an imaginary line in FIG. 4). Note that, the present embodiment has the plurality of (five) electrodeposition coating holes 40, but is not limited thereto as long as at least one electrodeposition coating hole 40 is formed.

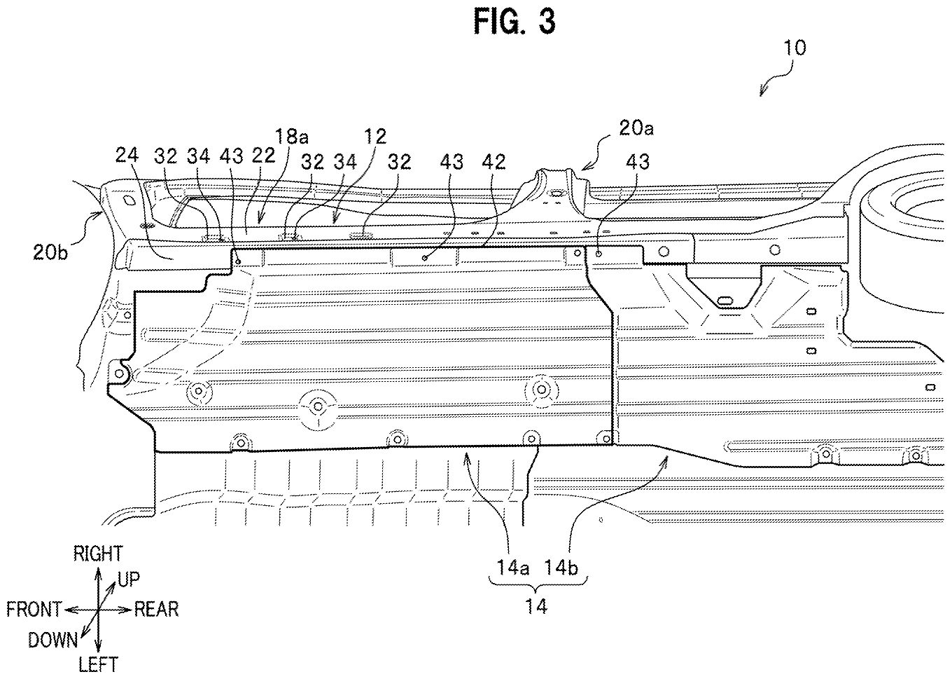

The undercover 14 is arranged between the right and left side sills 12 in a substantially horizontal direction, so as to cover a lower surface of the lower vehicle-body 10 (see FIG. 2). As shown in FIG. 1, the undercover 14 includes a front undercover 14a arranged at a front in the vehicle front-rear direction thereof and a rear undercover 14b arranged at a rear in the vehicle front-rear direction thereof, to be continuous to the front undercover 14a. As shown in FIG. 3, the front undercover 14a has, at lateral ends in the vehicle width direction thereof, the first flanges 42 extending to the outer bottom surfaces 24 of the side sills 12. The first flange 42 extends in the vehicle front-rear direction. The first flange 42 has the clip insertion holes 43 formed at positions to correspond to and to communicate with the clip insertion holes 38 of the outer side sill 18a (see FIGS. 8 and 9).

As shown in FIG. 5, the side sill garnish 16 serves as an exterior member for the side sill 12, and includes a garnish body 44, a fastening-and-fixing part 46, a hinge 48, an opening/closing part 50, and a second flange 52 arranged in a part of the opening/closing part 50, integrally formed of a resin material.

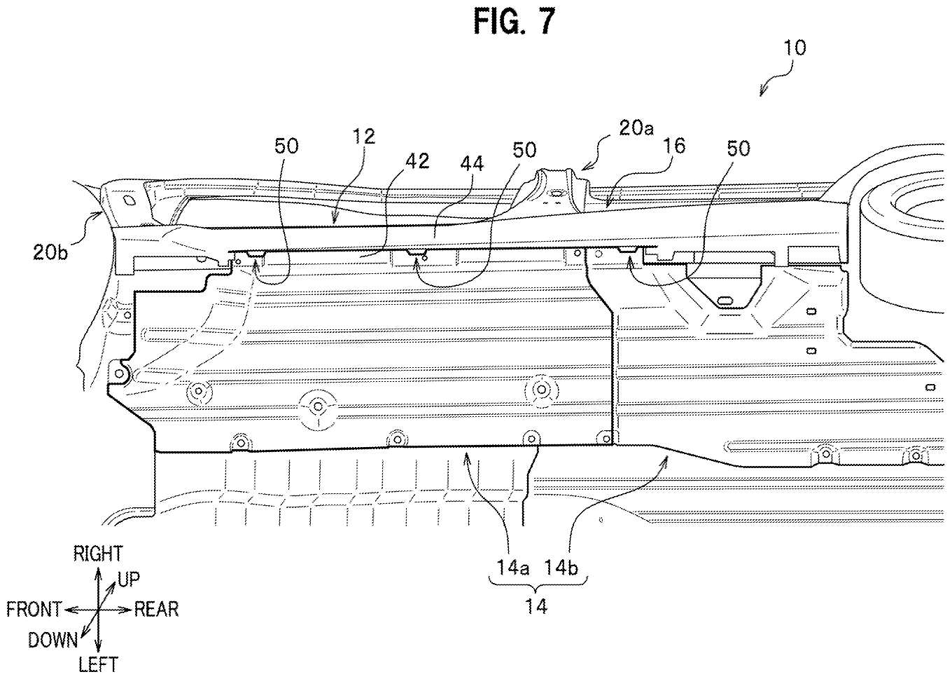

The hinge 48 is formed at a boundary connecting the garnish body 44 with the opening/closing part 50 to support the opening/closing part 50 so as to be opened/closed (see FIGS. 8, 9 and 7). The hinge 48 is recessed from an upper surface toward a lower surface of the garnish body 44, so that a wall thickness of the hinge 48 is smaller than wall thicknesses of the garnish body 44 and the opening/closing part 50 (see FIG. 8).

As shown in FIG. 8, when the hinge 48 is closed, the opening/closing part 50 is arranged to overlap the first flange 42 in the vehicle up-down direction. The opening/closing part 50 includes an opening/closing wall 54 continuous to the garnish body 44 via the hinge 48, and the second flange 52 continuous to an upper end of, and bent so as to be substantially perpendicular to, the opening/closing wall 54 (see FIGS. 8, 9, and 5).

As shown in FIG. 2, the second flange 52 is arranged at an inner end in the vehicle width direction of the side sill garnish 16 so as to extend in the vehicle front-rear direction. Further, the second flange 52 is arranged to cover the outer bottom surface 24 of the side sill 12 (outer side sill 18a) from outside in the vehicle width direction. Still further, when the hinge 48 is closed, the second flange 52 is positioned under the first flange 42 of the front undercover 14a so as to overlap the first flange 42 in the vehicle up-down direction (see FIG. 8). Yet further, three fastening parts 56 are formed at the second flange 52, as viewed from the bottom, to fasten together the three members, which are the first flange 42 of the front undercover 14a, the second flange 52 of the side sill garnish 16, and the outer bottom surface 24 of the side sill 12, when the hinge 48 is closed (see FIGS. 1, 8, and 9).

Each fastening part 56 has a substantially rectangular shape as viewed from the bottom, and includes a recessed part 58 which is recessed from a bottom surface of the second flange 52 toward the first flange 42, and a clip insertion hole 60 which is formed at the center of a bottom surface of the recessed part 58 and inserted with the clip 36 for fastening together (see FIG. 9). The recessed part 58 has a pair of partition walls 62 facing each other in the vehicle front-rear direction across the clip insertion hole 60.

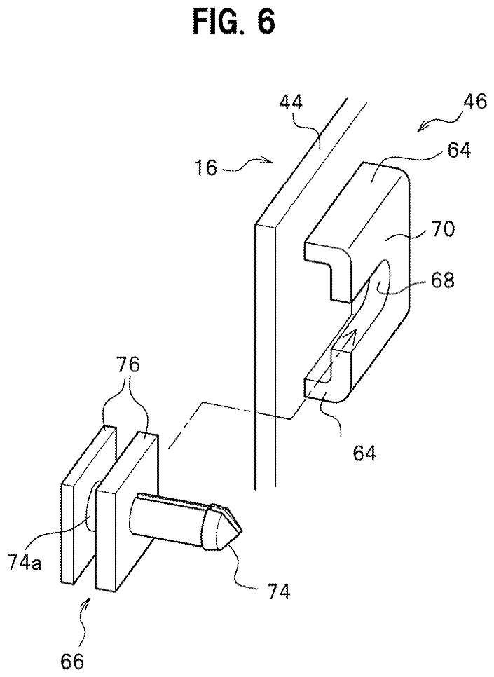

Further, the side sill garnish 16 is provided with the fastening-and-fixing parts 46 so as to be fastened and fixed to the side sill 12 at portions other than the outer bottom surface 24 of the side sill 12. As shown in FIG. 5, the fastening-and-fixing part 46 is arranged on the inner side in the vehicle width direction of the garnish body 44, and, as shown in FIG. 6, includes a clip locking part 70 which is apart from the garnish body 44 at a predetermined distance via a pair of legs 64 and has an elongated groove 68 into which a clip member 66 can slide.

As shown in FIG. 6, the clip member 66 includes a pin 74 to be inserted into the fastening-and-fixing hole 34 (see FIG. 5) formed in the sidewall center 22 of the outer side sill 18a, and a pair of holding plates 76 inserted onto a base end of the pin 74 and arranged to face each other, with a clearance in an axial direction of the pin 74. Note that the clearance between the pair of holding plates 76 is set to correspond to a plate thickness of the clip locking part 70 having the elongated groove 68.

With the pair of holding plates 76 holding the clip locking part 70 therebetween, the clip member 66 is slid along the elongated groove 68 in a direction indicated by an arrow in FIG. 6, until a part 74a of the pin 74 held between the pair of holding plates 76 reaches an end of the elongated groove 68. As a result, the clip member 66 is locked to the garnish body 44.

The first flange 42 of the front undercover 14a and the second flange 52 of the side sill garnish 16 are overlapped with each other in the vehicle up-down direction, and fastened together to the outer bottom surface 24 of the side sill 12 (outer side sill 18a) with use of a fastening element such as the clip 36 (see FIG. 2).

That is, the first flange 42 of the front undercover 14a, the second flange 52 of the side sill garnish 16, and the outer bottom surface 24 of the side sill 12 are respectively formed, at respective corresponding positions, with the plurality of clip insertion holes 38, 43, and 60 along the vehicle front-rear direction at predetermined intervals. The clips 36 are inserted into the clip insertion holes 38, 43, and 60 for fastening three plates together, respectively, so that the three members, which are the front undercover 14a, the side sill garnish 16, and the side sill 12, are integrally and firmly fastened together.

With the three members mentioned above fastened together with use of the clips 36, the outer bottom surface 24 of the side sill 12 is positioned at the uppermost layer, the second flange 52 of the side sill garnish 16 is positioned at the lowermost layer, and the first flange 42 of the front undercover 14a is interposed between the outer bottom surface 24 in the uppermost layer and the second flange 52 in the lowermost layer (see FIG. 8). In other words, the second flange 52 of the side sill garnish 16 is arranged lower in the vehicle body than the first flange 42 of the front undercover 14a.

The lower vehicle-body 10 applied with the lower vehicle-body structure according to the present embodiment is basically formed as described above, and a description is given below of advantageous effects thereof.

In the present embodiment, the first flange 42 of the front undercover 14a and the second flange 52 of the side sill garnish 16 are overlapped with each other in the vehicle up-down direction, and are fastened together to the outer bottom surface 24 of the side sill 12 with use of the clips 36.

In the present embodiment, the front undercover 14a and the side sill garnish 16 are respectively fastened and fixed to the side sill 12 serving as a frame member. This secures desired fastening rigidity, and a risk of the front undercover 14a and the side sill garnish 16 being separated from each other is reduced in the present embodiment. As a result, the present embodiment provides the lower vehicle-body structure which prevents the side sill garnish 16 and the front undercover 14a from being separated from each other. Further, even if either one of the front undercover 14a and the side sill garnish 16 is separated, for example, the other is kept fastened and fixed to the side sill 12, to prevent a decrease in fastening rigidity.

Further, the three members, which are the side sill 12, the front undercover 14a, and the side sill garnish 16, are fastened together with use of fastening elements such as the clips 36, so that stress applied to the front undercover 14a or the side sill garnish 16 is transmitted to the side sill 12. Thus, in the present embodiment, the stress applied to the lower vehicle-body 10 is avoided from being concentrated and is dispersed suitably.

Further, in the present embodiment, with the three members fastened together, the electrodeposition coating holes 40 formed in the outer bottom surface 24 of the side sill 12 are closed by the first flange 42. Conventionally, the electrodeposition coating holes 40, through which a coating film flows at a time of electrodeposition coating, are fitted with elastic bodies such as rubber so as to be closed, to prevent sound from being transmitted into a vehicle compartment.

In the present embodiment, with the three members described above fastened together with use of the clips 36, the electrodeposition coating holes 40 are closed by the first flange 42 of the front undercover 14a. Therefore, the present embodiment allows for reducing closing members such as rubber and skipping an operation for fitting the electrodeposition coating holes 40 such as with rubber. As a result, the lower vehicle-body structure in the present embodiment allows for reducing the number of elements and manufacturing costs as compared with a conventional one.

Further, in the present embodiment, the side sill garnish 16 is provided with the fastening-and-fixing parts 46 so as to be fastened and fixed to the side sill 12 at portions other than the outer bottom surface 24 of the side sill 12. In the present embodiment, having the fastening-and-fixing parts 46 further improves the fastening rigidity of the side sill garnish 16 to the side sill 12.

Further, with the three members fastened together, the second flange 52 of the side sill garnish 16 is arranged lower in the vehicle body than the first flange 42 of the front undercover 14a. In the present embodiment, the second flange 52 being arranged lower in the vehicle body than the first flange 42 allows for suitably supporting the front undercover 14a from below. Still further, in the present embodiment, even if the front undercover 14a collides with a curb or the like and is separated, for example, the side sill garnish 16 can maintain a fastening state.

Further, in the present embodiment, the side sill garnish 16 has the hinge 48 integrally formed of a resin material and supporting the opening/closing parts 50 so as to be opened and closed. Still further, the side sill garnish 16 has the opening/closing part 50 overlapping the first flange 42 of the front undercover 14a in the vehicle up-down direction, when the hinge 48 is closed (see FIG. 8).

In the present embodiment, the opening/closing part 50 can be suitably switched between an opened state (with the hinges 48 opened) and a closed state (with the hinges 48 closed) via the hinges 48. With the configuration described above, in the present embodiment, when the front undercover 14a is damaged, for example, the opening/closing parts 50 can be switched from an opened state to a closed state. This allows for easily replacing only the front undercover 14a, without removing the side sill garnish 16.

Further, in the present embodiment, at a time of assembling the vehicle body, the side sill garnish 16 is first attached to the side sill 12, with the opening/closing parts 50 opened (with the hinges 48 opened) and then the opening/closing parts 50 are switched to a closed state (with the hinges 48 closed) to mount the front undercover 14a. As described above, in the present embodiment, the opening/closing parts 50 being provided so as to be opened and closed via the hinges 48 allows for improving working efficiency.

What is claimed is:

1. A lower vehicle-body structure comprising:
side sills extending along a vehicle front-rear direction and provided on both sides in a vehicle width direction of a vehicle body, respectively;
an undercover covering a lower surface of the vehicle body and having a first flange which extends to an outer bottom surface of each of the side sills; and
a side sill garnish having a second flange covering the outer bottom surface of the side sill from outside in the vehicle width direction, wherein
the first flange and the second flange are overlapped with each other in a vehicle up-down direction, and are fastened together to the outer bottom surface part of the side sill.

2. The lower vehicle-body structure according to claim 1, wherein
the outer bottom surface of the side sill has at least one electrodeposition coating hole, and
the electrodeposition coating hole is closed by the first flange.

3. The lower vehicle-body structure according to claim 1, wherein
the side sill garnish is fastened to the vehicle body at least at one portion other than the outer bottom surface of the side sill, and
the second flange is arranged lower in the vehicle body than the first flange.

4. The lower vehicle-body structure according to claim 1, wherein
the side sill garnish has a hinge integrally formed of a resin material and supporting an opening/closing part thereof so as to be opened and closed; and
the side sill garnish has the opening/closing part overlapping the first flange in the vehicle up-down direction, when the hinge is closed.
